(19) United States
(12) Patent Application Publication
(10) Pub. No.: US 2015/0198871 A1
(43) Pub. Date: Jul. 16, 2015

(54) PROJECTOR ADAPTER PLATE

(71) Applicant: James Michael Piraino, Conway, AR (US)

(72) Inventor: James Michael Piraino, Conway, AR (US)

(21) Appl. No.: 14/556,646

(22) Filed: Dec. 1, 2014

Related U.S. Application Data
(60) Provisional application No. 61/928,289, filed on Jan. 16, 2014.

(51) Int. Cl. G03B 21/54; F16M 13/02

(52) U.S. Cl. CPC G03B 21/54; F16M 13/022

(57) ABSTRACT

An adaptor plate to connect projectors to booms is provided. The plate is substantially flat and has an upper surface and a lower surface. The upper surface may face towards the boom and the lower surface may face towards the projector. Four substantially narrow slots are formed through the plate. The slots are positioned to receive and secure four legs protruding from the boom. The legs may lock into the corresponding slot. A boundary may be formed around the slots. The plate may further include a plurality of mounting holes in between the rim and the boundary. The plurality of mounting holes are each sized to receive a bolt connecting the plate to the projector.

### CROSS-REFERENCE TO RELATED APPLICATION

This application claims the benefit of priority of U.S. provisional application No. 61/928,289, filed Jan. 16, 2014, the contents of which are herein incorporated by reference.

### BACKGROUND OF THE INVENTION

The present invention relates to projectors and, more particularly, to projector adapter plates.

Smart™ Technologies made and sold hundreds of thousands of UF55™, UF55W™, UF65™, and UF65W™ projectors and they had a very high failure rate. Furthermore, most of these projectors are now out of warranty. The cost of replacing an out of warranty projector can be extremely high unless you can utilize the existing wall mounting plate, projector boom, and projector locking mechanism. Finally, there is an additional cost associated with removing the existing boom and fixing the holes in the walls made by the SMART boom. Many of these projectors reside in K12 and Higher Education institutions where budgets are extremely tight.

As can be seen, there is a need for an adapter plate to attach new projectors to the Smart™ Technologies boom.

### SUMMARY OF THE INVENTION

In one aspect of the present invention, an adaptor plate for projectors comprises: a substantially flat plate comprising an upper surface, a lower surface and a rim formed along an outer perimeter of the plate, wherein four slots are formed through the plate, the four slots positioned to receive and secure four legs protruding from a boom, wherein a boundary surrounds the four slots, wherein a plurality of mounting holes are formed through the plate in between the rim and the boundary, wherein the plurality of mounting holes are each sized to receive a bolt connecting the plate to a projector.

These and other features, aspects and advantages of the present invention will become better understood with reference to the following drawings, description and claims.

### BRIEF DESCRIPTION OF THE DRAWINGS

FIG. 1 is a perspective view of the present invention in use;

FIG. 2 is an exploded perspective view of a first embodiment of the present invention;

FIG. 3A is a top plan view of the adaptor plate of the first embodiment;

FIG. 3B is a bottom plan view of the adaptor plate of the first embodiment;

FIG. 4 is a typical cross-section of the mounting of the adaptor plate; and

FIG. 5 is a top plan view of the adaptor plate of the second embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims

The present invention includes a custom plate to replace SMART™ UF55™ and UF65™ projectors with NEC™, Epson™, and Casio™ projectors using the existing mount on the SMART™ boom to attach the NEC™, Epson™, or Casio™ projector to the boom. This plate gives end users a way to keep the projector mount in place and remove just the broken SMART™ projector and install a new projector at a lower price. Further, in certain embodiments, the plate of the present invention may provide three or more different manufacturers to pick from.

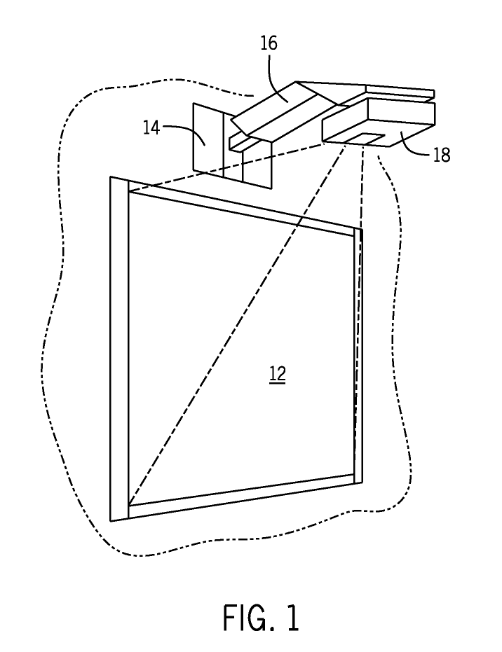

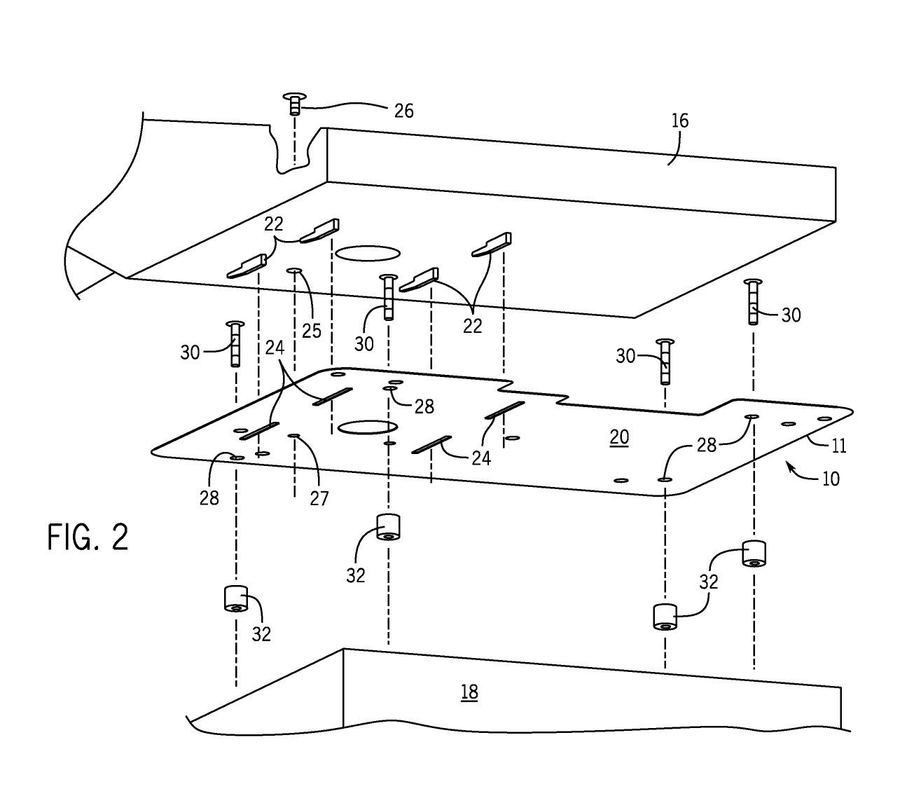

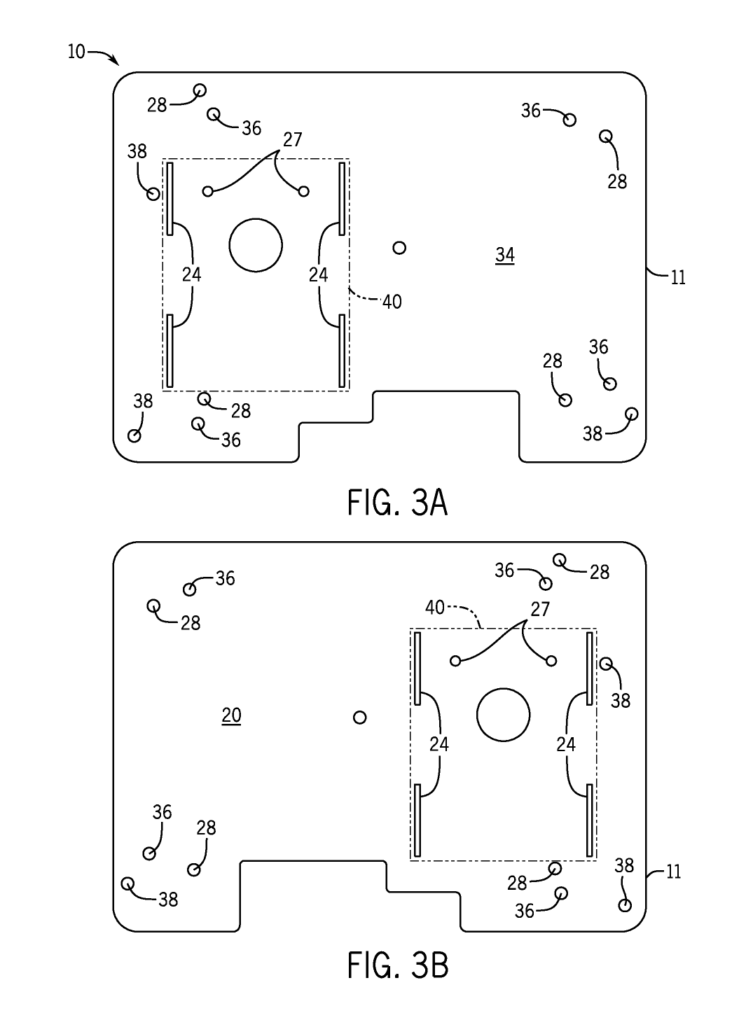

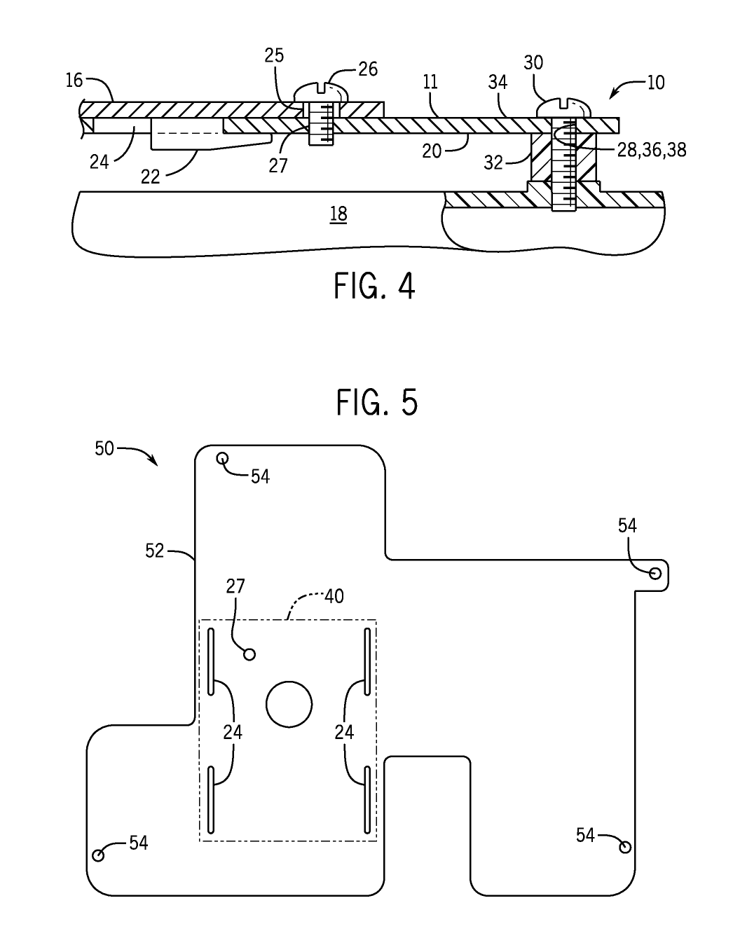

Referring to FIGS. 1 through 5, the present invention includes an adaptor plate 10 to connect projectors 18 to booms 16. The plate 10 is substantially flat and has an upper surface 34 and a lower surface 20. The upper surface 34 may face towards the boom 16 and the lower surface 20 may face towards the projector 18. Four substantially narrow slots 24 are formed through the plate 10. The slots 24 are positioned to receive and secure four legs 22 protruding from the boom 16. The legs 22 may lock into the corresponding slot 24. A boundary 40 may be formed around the slots 24. The plate 10 may further include a plurality of mounting holes 28 in between the rim and the boundary 40. The plurality of mounting holes 28 are each sized to receive a bolt 30 or screw connecting the plate 10 to the projector 18.

As mentioned above, the adapter plate 10 is used to attach NEC™, Epson™, and Casio™ projectors 18 to a Smart™ boom 16 attached to a wall mounting bracket 14 to project on a screen 12. In such embodiments, the plate 10 may include four corner portions. The plurality of mounting holes 28 may be disposed near the four corner portions. For example, a projector 18 may include four receiving holes. The plate 10 may include a mounting hole 28 in each of the four corner portions that aligns with the four receiving holes of the projector 18. Screws 30 or bolts may secure the plate 10 through the aligned mounting holes 28 and receiving holes.

In certain embodiments, the plate 10 may secure to a plurality of different projectors 18. In such embodiments, the plurality of mounting holes 28 may include a first set 28, a second set 36, and a third set 38. The first set 28 may align with receiving holes of a first type of projector 18, the second set 36 may align with receiving holes of a second type of projector 18, and the third set 38 may align with receiving holes of a third type of projector 18. Therefore, the same plate 10 may be used with different types of projectors 18.

The plate 10 of the present invention may be further secured to the boom 16 by a locking screw 26. In such embodiments, the plate 10 may include at least one threaded receiver 27, such as two threaded receivers 27. The threaded receiver 27 may be within the boundary between the four slots 24. The threaded receiver 27 may align with a locking hole 25 of the boom 16. A locking screw 26 or bolt may run through the locking hole 25 and the threaded receiving hole 27 further securing the plate 10 to the boom 16.

In certain embodiments, the boom 16 may include a large opening to receive a user's hand so that the user may attach the locking screw 26 to the plate 10. In such embodiments, the plate 10 may include a large opening within the boundary between the four slots 24 that aligns with the large opening of the boom 16. Therefore, when attaching the plate 10 to the boom 16, the user may reach through the plate 10 and the boom 16 to tighten the locking screw 26. In certain embodiments, spacers 32, such as discs with slots therethrough, may fit through the mounting screws 30 and provide space between the plate 10 and the projector 18. This allows users to fit their hand in between to manipulate the locking screw 26.

The plate 10 of the present invention may come in different sizes and shapes and work with multiple models and brands of projectors. For example, the present invention may include a first embodiment 11, with the plurality of holes 28, 36, 28 arranged as mentioned above. The present invention may further include a second embodiment 50 including a second plate 52. The second embodiment 50 may include only a single set 54 of the plurality of holes. The shape of the second embodiment 50 may be different to conserve materials, cheapen production, and conform to the shape of different projectors 18.

It should be understood, of course, that the foregoing relates to exemplary embodiments of the invention and that modifications may be made without departing from the spirit and scope of the invention as set forth in the following claims.

What is claimed is:

1. An adaptor plate for projectors comprising:
a substantially flat plate comprising an upper surface, a lower surface and a rim formed along an outer perimeter of the plate,
wherein four slots are formed through the plate, the four slots positioned to receive and secure four legs protruding from a boom, wherein a boundary surrounds the four slots,
wherein a plurality of mounting holes are formed through the plate in between the rim and the boundary, wherein the plurality of mounting holes are each sized to receive a bolt connecting the plate to a projector.

2. The adapter plate of claim 1, wherein the plate comprises four corner portions.

3. The adapter plate of claim 2, wherein the plurality of mounting holes are disposed near the four corner portions.

4. The adapter plate of claim 1, wherein the plurality of mounting holes comprises at least a first set of holes spaced to align with receiving holes of a first type of projector.

5. The adapter plate of claim 4, wherein the plurality of mounting holes further comprises a second set of holes spaced to align with receiving holes of a second type of projector.

6. The adapter plate of claim 5, wherein the plurality of mounting holes further comprises a third set of holes spaced to align with receiving holes of a third type of projector.

7. The adapter plate of claim 1, further comprising a plurality of spacers, each of the plurality of spacers overlapping a bolt connecting the plate to the projector.

8. The adapter plate of claim 1, further comprising an opening formed through the plate within the boundary.

9. The adapter plate of claim 1, further comprising at least one threaded receiving hole within the boundary position to align with a locking hole of the boom, wherein a locking screw runs through the locking hole and threaded receiving hole, further securing the plate to the boom.

10. The adapter plate of claim 9, wherein the at least one threaded receiving hole within the boundary is two threaded receiving holes.
